(19) United States
(12) Patent Application Publication
(10) Pub. No.: US 2012/0156571 A1
(43) Pub. Date: Jun. 21, 2012

(54) ELECTRODE FOR BATTERIES, BATTERY COMPRISING THE ELECTRODE, AND METHOD FOR PRODUCING THE BATTERY

(76) Inventors: Koji Kawamoto, Nishikamo-gun (JP); Shigenori Hama, Susono-shi (JP); Satoshi Wakasugi, Gotenba-shi (JP)

(21) Appl. No.: 13/376,411

(22) PCT Filed: Jan. 15, 2010
(86) PCT No.: PCT/JP2010/050425

§ 371 Date: Feb. 28, 2012

(51) Int. Cl. H01M 10/056; B29D 99/00; H01B 1/12

(52) U.S. Cl. 429/306; 252/500; 264/104

(57) ABSTRACT

An object of the present invention is to provide an electrode for batteries which enables a battery to provide high output power when it is incorporated in the battery, a battery comprising the electrode, and a method for producing the electrode.

Disclosed is an electrode for batteries, comprising an inorganic solid electrolyte, an electrode active material and a polymer compound dispersed in the inorganic solid electrolyte.

### TECHNICAL FIELD

The present invention relates to an electrode for batteries which enables a battery to provide high output power when it is incorporated in the battery, a battery comprising the electrode, and a method for producing the electrode.

### BACKGROUND ART

A secondary battery is a battery which is able to provide electricity by converting a decrease in chemical energy associated with a chemical reaction into electrical energy; moreover, it is a battery which is able to store (during charge) chemical energy by converting electrical energy into chemical energy by passing an electric current in a direction that is opposite to the discharge direction. Among secondary batteries, lithium secondary batteries have high energy density and are thus widely used as a power source for notebook personal computers, cellular phones and other portable devices.

In a lithium secondary battery using graphite (C₆) as the negative electrode active material, the reaction described by the following formula (1) proceeds at the negative electrode upon discharge:

C₆Li→C₆+Li⁺+e⁻ (1)

An electron produced by the formula (1) passes through an external circuit, activates an external load, and then reaches the positive electrode. At the same time, a lithium ion (Li⁺) produced by the formula (1) is transferred through the electrolyte sandwiched between the negative and positive electrodes from the negative electrode side to the positive electrode side.

When lithium cobaltate (Li_{0.4}CoO₂) is used as a positive electrode active material, the reaction described by the following formula (2) proceeds at the positive electrode upon discharge:

Li_{0.4}CoO₂+0.6Li⁺+0.6e⁻→LiCoO₂ (2)

Upon charging the battery, reactions which are reverse to the reactions described by the above formulae (1) and (2) proceed at the negative and positive electrodes. The graphite material in which lithium was intercalated (C₆Li) becomes reusable at the negative electrode, while lithium cobaltate (Li_{0.4}CoO₂) is regenerated at the positive electrode. Because of this, discharge becomes possible again.

In lithium secondary batteries, as the charge and discharge cycle progresses, the active material in the electrodes repeats expansion and shrinkage; therefore, there is a problem that a contact failure with the case or seal plate takes place or the connection between particles in the electrodes becomes loose. As a lithium secondary battery technique developed to solve the problems, Patent Literature 1 disclosed an all-solid-state lithium battery in which a lithium ion conductive solid electrolyte is sandwiched between the positive and negative electrodes facing each other, and at least one of the electrode materials of the positive and negative electrodes comprises a powdery lithium ion conductive inorganic solid electrolyte and an active material covered with a lithium ion conductive polymer.

### CITATION LIST

Patent Literature 1: Japanese Patent Application Laid-Open (JP-A) No. H11-7942

### SUMMARY OF INVENTION

### Technical Problem

Patent Literature 1 has no description on the problems between different types of materials, such as a problem with interface resistance between a lithium ion conductive polymer and a lithium ion conductive inorganic solid electrolyte.

The present invention was made in the light of this circumstance, and an object of the present invention is to provide an electrode for batteries which enables a battery to provide high output power when it is incorporated in the battery, a battery comprising the electrode, and a method for producing the electrode.

### Solution to Problem

The electrode for batteries of the present invention comprises an inorganic solid electrolyte, an electrode active material and a polymer compound dispersed in the inorganic solid electrolyte.

Because such an electrode for batteries comprises the polymer compound, the resistance of an interface between the electrode active material and the inorganic solid electrolyte can be decreased; therefore, when the electrode is incorporated in a battery, the battery is able provides high power output.

In the electrode for batteries of the present invention, the polymer compound is preferably synthetic rubber.

An embodiment of the electrode for batteries of the present invention is such that the polymer compound is butadiene rubber or styrene-butadiene rubber.

An embodiment of the electrode for batteries of the present invention is such that the polymer compound is in a powder form.

In the electrode for batteries of the present invention, a content ratio of the polymer compound is preferably 1 to 30 vol % when a total content of the inorganic solid electrolyte and the polymer compound is 100 vol %.

The electrode having such a structure comprises the polymer compound in an appropriate amount; therefore, when incorporated in a battery, the battery is able to decrease resistance, especially resistance after a long period of use.

The battery of the present invention is a battery comprising at least a positive electrode, a negative electrode and an electrolyte layer present between the positive and negative electrodes, wherein at least one of the positive and negative electrodes is the electrode for batteries of the present invention.

The method for producing an electrode for batteries of the present invention comprises the steps of: mixing an inorganic solid electrolyte material and a polymer compound material; pulverizing and mixing the thus-obtained mixture of the inorganic solid electrolyte material and the polymer compound material; and forming an electrode for batteries by mixing the mixture pulverized and mixed in the pulverizing and mixing step with an electrode active material and then welding them together.

The electrode for batteries of the present invention is obtained by the electrode production method of such a structure. In the electrode production method of such a structure, the polymer compound material is uniformly dispersed in the inorganic solid electrolyte material in the pulverizing and mixing step; therefore, a resistive layer at the interface between the electrode active material and the inorganic solid electrolyte is eliminated, thereby obtaining an electrode with high ion conductivity.

### Advantageous Effects of Invention

According to the present invention, because the electrode comprises the polymer compound, the resistance of the interface between the electrode active material and the inorganic solid electrolyte can be decreased; therefore, when the electrode is incorporated in a battery, the battery is able to provide high output power.

### BRIEF DESCRIPTION OF DRAWINGS

FIG. 1 is a view showing an example of the lithium-air battery according to the present invention, and it is also a schematic sectional view of the battery cut along the laminating direction.

FIG. 2 are graphs, one of which showing a comparison between the initial resistances of all-solid-state secondary batteries of Examples 1 to 4 and Comparative Examples 1, 3 and 4, the other of which showing a comparison between the resistances of the same after 100 cycles of operation.

### DESCRIPTION OF EMBODIMENTS

### 1. Electrode for Batteries

The electrode for batteries of the present invention comprises an inorganic solid electrolyte, an electrode active material and a polymer compound dispersed in the inorganic solid electrolyte.

Conventional all-solid-state batteries comprising a solid electrolyte and an electrode active material has a problem that, especially when they are pressure-molded at a temperature which is more than the softening temperature and less than the glass transition temperature, they cause expansion and shrinkage by repeating charge and discharge; therefore, stress is generated at the interface between a solid electrolyte and an electrode active material and causes detachment at the interface, thereby disconnecting an ion conductive path and thus resulting in an increase in resistance. It is also a problem of conventional all-solid-state batteries that electrolyte is cracked by expansion and shrinkage of the batteries, so that they cannot keep high durability.

Also in conventional all-solid-state batteries comprising a solid electrolyte and electrode active material, a resistive layer is present at the interface between the solid electrolyte and the electrode active material; therefore, high power output cannot be expected.

As the result of diligent researches, the inventors of the present invention found out that a resistive layer at the interface between the solid electrolyte and the electrode active material, which is present in any of conventional electrodes for batteries, is eliminated by incorporating a polymer compound in an electrode, in addition to an inorganic solid electrolyte and electrode active material; therefore, when the electrode is incorporated in a battery, the battery is able to provide high output power. In addition, the inventors found out that the polymer compound eliminates the stress caused by a change in volume of the whole electrode due to charge and discharge; therefore, when the electrode is incorporated in a battery, it contributes to increasing the durability of the whole battery.

The inorganic solid electrolyte used in the present invention is not particularly limited as long as it is an ion-conductive inorganic solid. In particular, there may be mentioned a solid oxide electrolyte and a solid sulfide electrolyte.

As the solid oxide electrolyte, in particular, there may be mentioned LiPON (lithium phosphorus oxynitride), Li_{1.3}Al_{0.3}Ti_{0.7}(PO₄)₃, La_{0.51}Li_{0.34}TiO_{0.74}, Li₃PO₄, Li₂SiO₂, Li₂SiO₄, Li_{0.5}La_{0.5}TiO₃, Li_{1.5}Al_{0.5}Ge_{1.5}(PO₄)₃, etc.

Concrete examples of the solid sulfide electrolyte include Li₃PS₄, Li₂S—P₂S₅, Li₂S—P₂S₃, Li₂S—P₂S₃—P₂S₅, Li₂S—SiS₂, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, Li₄₋ₓGe₁₋ₓPₓS₄ and Li₇P₃S₁₁.

The polymer compound is present in the electrode of the present invention in the state that the compound is dispersed in the inorganic solid electrolyte. In the case where, as in conventional electrode production methods, the inorganic solid electrolyte and polymer compound are each dissolved a solvent and then mixed, in the electrode for batteries obtained by the production method, the surface of the inorganic solid electrolyte fine particles is covered with the polymer compound to form a polymer film, and the polymer film becomes a resistive layer. In the electrode for batteries of the present invention, however, the polymer compound is present in the inorganic solid electrolyte in a highly dispersed state; therefore, it has no possibility of disturbing electron conduction and lithium ion conduction.

An embodiment of the electrode for batteries of the present invention is such that the polymer compound is in a powder form.

The polymer compound used in the present invention is preferably synthetic rubber. The synthetic rubber used in the present invention is not particularly limited as long as it is a chemically-synthesized polymer compound which shows rubber elasticity. Concrete examples thereof include butadiene rubber, isoprene rubber, styrene-butadiene rubber (SBR), ethylene-propylene rubber, butyl rubber, chloroprene rubber, acrylonitrile-butadiene rubber, acrylic rubber, urethane rubber, silicone rubber and fluoro rubber. Among them, butadiene rubber or styrene-butadiene rubber is preferably used.

The content ratio of the polymer compound is preferably 1 to 30 vol % when the total content of the inorganic solid electrolyte and the polymer compound is 100 vol %. Because the electrode for batteries of the present invention contains the polymer compound at a content ratio in the range, when incorporated in a battery, the electrode is able to decrease resistance, especially resistance after a long period of use.

If the content ratio of the polymer compound is less than 1 vol %, the effect of eliminating the stress which is generated at the interface between the solid electrolyte and the electrode active material upon charge and discharge, the effect being exerted by the addition of the polymer compound, cannot be sufficiently exerted. Therefore, it is not possible to decrease resistance. If the content ratio of the polymer compound exceeds 30 vol %, the content ratio of the inorganic solid electrolyte is relatively small; therefore, there is a possible increase in resistance.

The content ratio of the polymer compound is more preferably 5 to 10 vol % when the total content of the inorganic solid electrolyte and the polymer compound is 100 vol %.

The electrode active material used in the present invention will be explained in detail under “Positive electrode active material layer” and “Negative electrode active material layer” explained below.

A typical example of the electrode for batteries of the present invention is an electrode for lithium secondary batteries. Hereinafter, the case where the electrode for batteries of the present invention is used for the positive electrode of a lithium secondary battery will be described, as well as the case where the electrode is used for the negative electrode of a lithium secondary battery.

1-1. The Case where the Electrode for Batteries of the Present Invention is Used for the Positive Electrode of a Lithium Secondary Battery

The positive electrode of the lithium secondary battery of the present invention comprises an electrode for batteries produced by the production method of the present invention. Preferably, it further comprises a positive electrode lead connected to the electrode for batteries.

Hereinafter, positive electrode active material layer and positive electrode current collector will be described.

### (Positive Electrode Active Material Layer)

As the positive electrode active material used in the present invention, in particular, there may be mentioned LiCoO₂, LiNi_{1/3}Mn_{1/3}Co_{1/3}O₂, LiNiPO₄, LiMnPO₄, LiNiO₂, LiMn₂O₄, LiCoMnO₄, Li₂NiMn₃O₈, Li₃Fe₂(PO₄)₃, Li₃V₂(PO₄)₃, etc. Among them, LiCoO₂ is preferably used as the positive electrode active material in the present invention.

The thickness of the positive electrode active material layer used in the present invention varies depending on the intended application and so on of the lithium secondary battery. It is preferably in the range of 10 μm to 250 μm, more preferably in the range of 20 μm to 200 μm, still more preferably in the range of 30 μm to 150 μm.

The average particle diameter of the positive electrode active material is, for example, preferably in the range of 1 μm to 50 μm, more preferably in the range of 1 μm to 20 μm, still more preferably in the range of 3 μm to 10 μm. This is because it could be difficult to handle the positive electrode active material when the average particle diameter of the material is too small, and it could be difficult to make the positive electrode active material layer a flat layer when the average particle diameter of the positive electrode active material is too large. The average particle diameter of the positive electrode active material can be obtained by, for example, measuring the diameter of active material carrier particles observed with a scanning electron microscope (SEM) and averaging the thus-obtained particle diameters.

The positive electrode active material layer can comprise a conducting material, a binder, etc., as needed.

The conducting material contained in the positive electrode active material layer used in the present invention is not particularly limited as long as it is able to increase the electrical conductivity of the positive electrode active material layer. For example, there may be mentioned carbon black such as acetylene black and ketjen black. The content of the conducting material in the positive electrode active material layer varies depending on the type of conducting material, and it is normally in the range of 1% by mass to 10% by mass.

As the binder contained in the positive electrode active material layer used in the present invention, there may be mentioned polyvinylidene fluoride (PVDF) and polytetrafluoroethylene (PTFE), for example. The content of the binder in the positive electrode active material layer is only needed to be an amount which can fix the positive electrode active material, etc., and it is preferably as small as possible. The content of the binder is normally in the range of 1% by mass to 10% by mass.

### (Positive Electrode Current Collector)

The positive electrode current collector used in the present invention functions to collect current from the positive electrode active material layer. As the material for the positive electrode current collector, for example, there may be mentioned aluminum, stainless steel (SUS), nickel, iron and titanium. Among them, aluminum and SUS are preferred. As the form of the positive electrode current collector, there may be mentioned a foil form, a plate form and a mesh form, for example. Among them, a foil form is preferred.

1-2. The Case where the Electrode for Batteries of the Present Invention is Used for the Negative Electrode of a Lithium Secondary Battery

The negative electrode in the lithium secondary battery of the present invention comprises the electrode for batteries which is produced by the production method of the present invention. Preferably, it further comprises a negative electrode lead which is connected to the electrode for batteries.

Hereinafter, negative electrode active material layer and negative electrode current collector will be explained.

### (Negative Electrode Active Material Layer)

The negative electrode active material used for the negative electrode active material layer is not particularly limited as long as it can store and release a lithium ion. For example, there may be mentioned metallic lithium, a lithium alloy, a metal oxide, a metal sulfide, a metal nitride and a carbonaceous material such as graphite. The negative electrode active material can be in a powder form or in a thin film form.

The negative electrode active material layer can comprise a conducting material, a binder, etc., as needed.

As the binder and conducting material which can be used in the negative electrode active material layer can be the same as those mentioned above under “Positive electrode active material layer.” Preferably, the used amount of the binder and conducting material are appropriately selected depending on the intended application, etc., of the lithium secondary battery. The thickness of the negative electrode active material layer is not particularly limited, and it is preferably in the range of 10 μm to 100 μm, more preferably in the range of 10 μm to 50 μm.

### (Negative Electrode Current Collector)

Copper is also usable as the material for the negative electrode current collector, in addition to the above-mentioned materials for the positive electrode current collector. The form of the negative electrode current collector can be the same as that of the positive electrode current collector mentioned above.

The negative electrode of the present invention is produced by the above-described method for producing an electrode for batteries of the present invention.

The electrode for batteries of the present invention is not limited to the above-described electrode for lithium secondary batteries. That is, as described above, the electrode for batteries of the present invention encompasses any electrode for batteries which comprises an inorganic solid electrolyte, an electrode active material and a polymer compound.

### 2. Battery

The battery of the present invention comprises at least a positive electrode, a negative electrode and an electrolyte layer present between the positive and negative electrodes, wherein at least one of the positive and negative electrodes is the above-described electrode for batteries.

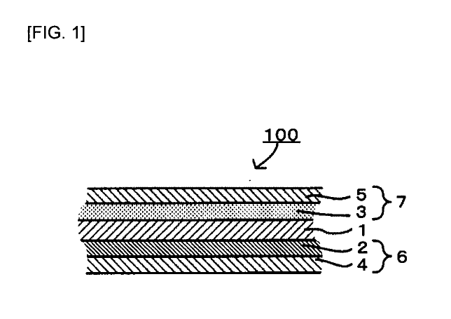

FIG. 1 shown an example of the battery of the present invention, and it is also a schematic sectional view of the battery cut along the stacking direction. The battery of the present invention is not limited to this example only. FIG. 1 shows a lamination type battery only; however, besides this, a wound type battery can be used, for example.

Battery 100 comprises positive electrode 6 comprising positive electrode active material layer 2 and positive electrode current collector 4; negative electrode 7 comprising negative electrode active material layer 3 and negative electrode current collector 5; and electrolyte layer 1 sandwiched between positive electrode 6 and negative electrode 7. Battery 100 comprises the electrode for batteries of the present invention as the positive electrode and/or the negative electrode.

A typical example of the battery of the present invention is a lithium secondary battery. Hereinafter, lithium ion conductive electrolyte layer, which is a component of the lithium secondary battery that is a typical example of the present invention, and other component (such as separator) will be explained.

### (Lithium Ion Conductive Electrolyte Layer)

The lithium ion conductive electrolyte layer used in the present invention is not particularly limited as long as it has lithium ion conductivity, and it can be solid or liquid. There may be used a polymer electrolyte, a gel electrolyte, etc.

As the lithium ion conductive solid electrolyte layer used in the present invention, in particular, there may be used the above-described solid oxide electrolyte, solid sulfide electrolyte, etc.

As the lithium ion conductive electrolyte used in the present invention, in particular, there may be used an aqueous electrolyte and a non-aqueous electrolyte.

As the aqueous electrolyte used for the lithium secondary battery, lithium salt-containing water is generally used. As the lithium salt, for example, there may be mentioned an inorganic lithium salt such as LiPF₆, LiBF₄, LiClO₄ and LiAsF₆, and an organic lithium salt such as LiCF₃SO₃, LiN(SO₂CF₃)₂(Li-TFSI), LiN(SO₂C₂F₅)₂ and LiC(SO₂CF₃)₃.

Preferably, the type of non-aqueous electrolyte used in the present invention is appropriately selected depending on the type of metal ions to be conducted. For example, the non-aqueous electrolyte of the lithium secondary battery generally contains a lithium salt and a non-aqueous solvent. As the lithium salt, there may be used the above-described salts. As the non-aqueous solvent, for example, there may be mentioned ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile, 1,2-dimethoxymethane, 1,3-dimethoxypropane, diethyl ether, tetrahydrofuran, 2-methyltetrahydrofuran and mixtures thereof. The concentration of the lithium salt in the non-aqueous electrolyte is in the range of 0.5 mol/L to 3 mol/L, for example.

In the present invention, as the non-aqueous electrolyte, a low-volatile liquid such as an ionic liquid can be contained, for example.

The polymer electrolyte used in the present invention preferably contains a lithium salt and a polymer. As the lithium salt, there may be mentioned the above-described salts. The polymer is not particularly limited as long as it can form a complex with the lithium salt, and there may be mentioned polyethylene oxide, for example.

The gel electrolyte used in the present invention preferably contains a lithium salt, a polymer and a non-aqueous solvent.

As the lithium salt, there may be used the above-described lithium salts.

As the non-aqueous solvent, there may be used the above-described non-aqueous solvents. They can be used solely or in combination of two or more kinds. As the non-aqueous electrolyte, an ambient temperature molten salt can be also used.

The polymer is not particularly limited as long as it can gel. For example, there may be mentioned polyethylene oxide, polypropylene oxide, polyacrylonitrile, polyvinylidene fluoride (PVDF), polyurethane, polyacrylate and cellulose.

### (Other Component)

A separator can be used for the battery of the present invention as the other component. The separator is disposed between the above-described positive electrode current collector and negative electrode current collector. In general, it functions to prevent contact between the positive electrode active material layer and the negative electrode active material layer and to retain the solid electrolyte. As the material for the separator, for example, there may be mentioned resins such as polyethylene (PE), polypropylene (PP), polyester, cellulose and polyamide. Among them, polyethylene and polypropylene are preferred. The separator can be of a monolayer structure or multilayer structure. As the separator having a multilayer structure, for example, there may be mentioned a separator having a two layer structure (PE/PP) and a separator having a three-layer structure (PP/PE/PP). Also in the present invention, the separator can be a non-woven fabric such as a resin non-woven fabric or glass fiber non-woven fabric. The thickness of the separator is not particularly limited and is the same as the thickness of the separator which is used for general lithium secondary batteries.

### 3. Method for Producing an Electrode for Batteries

The method for producing an electrode for batteries of the present invention comprises the steps of: mixing an inorganic solid electrolyte material and a polymer compound material; pulverizing and mixing the thus-obtained mixture of the inorganic solid electrolyte material and the polymer compound material; and forming an electrode for batteries by mixing the mixture pulverized and mixed in the pulverizing and mixing step with an electrode active material and then welding them together.

Hereinafter, the three steps of the production method of the present invention will be described in order. The production method of the present invention is not limited to the three steps, however.

### 3-1. The Step of Mixing an Inorganic Solid Electrolyte Material and a Polymer Compound Material

In this step, first, the above-described inorganic solid electrolyte material and polymer compound are taken and mixed together. The mixing in this step is a preliminary mixing which is performed in the step prior to the below-described pulverizing and mixing step; therefore, the mixing method is not particularly limited and a general mixing method can be employed, such as stirring and mixing using a stirrer, etc.

From the viewpoint of uniform mixing, it is preferable to dissolve the polymer compound material in a solvent in advance, before mixing the inorganic solid electrolyte material with the polymer compound material.

As the solvent, depending on the polarity of the polymer compound material to be a solute, it is preferable to use a solvent having a relatively low boiling point, from the viewpoint of quick removal. Usable solvents are n-heptane, toluene, xylene, hexane and decane, for example. Among them, it is preferable to use n-heptane which is easy to handle and has a relatively low boiling point of 98° C.

In the case of using a solvent, it is preferable to remove the solvent by drying or partially drying the mixture of the solid electrolyte material and the polymer compound material after the preliminary mixing. The drying method can be heat-drying, reduced-pressure drying, or the like. In the case of heat-drying, it is preferable to perform drying in the temperature condition of 60 to 120° C. for 1 to 50 hours.

After the completion of this step, the form of the polymer compound material is in the state that the solid electrolyte material is covered with the polymer compound material which is in a layer form.

3-2. The Step of Pulverizing and Mixing the Mixture of the Inorganic Solid Electrolyte Material and the Polymer Compound material.

In this step, the pulverizing and mixing method is not particularly limited. In particular, there may be mentioned a mechanical milling method, etc., from the point of view that it is possible to perform pulverizing and mixing at normal temperature and to simplify the production process.

The mechanical milling is not particularly limited as long as it is a method of pulverizing and mixing the mixture of the inorganic solid electrolyte material and the polymer compound material by giving mechanical energy to the mixture. For example, there may be mentioned a ball mill, a turbo mill, mechanofusion and a disk mill. Among them, preferred is a ball mill. From the viewpoint of dispersing the polymer compound material of the mixture in the mixture uniformly in a powder form, a planetary boll mill is more preferred.

The mechanical milling conditions can be appropriately controlled. For example, in the case of pulverizing and mixing the mixture with a planetary boll mill, the materials (mixed in advance with a agate mortar or the like) and a ball for pulverization are placed in a pot and treated at a predetermined number of revolutions and for a predetermined time. In the case of using a planetary boll mill, the number of revolutions is preferably in the range of 50 rpm to 1,000 rpm, more preferably in the range of 200 rpm to 500 rpm. Also in the case of using a planetary boll mill, the treatment time is preferably in the range of 0.1 hour to 100 hours, more preferably in the range of 5 hours to 50 hours.

The polymer compound material of the mixture of the inorganic solid electrolyte material and the polymer compound material can be uniformly dispersed in the mixture by the pulverizing and mixing step.

3-3. The Step of Forming an Electrode for Batteries by Mixing the Pulverized and Mixed Mixture of the Inorganic Solid Electrolyte Material and the Polymer Compound Material with an Electrode Active Material and then Welding them Together.

The welding method is not particularly limited as long as it is a method by which the mixture of the inorganic solid electrolyte material and the polymer compound material and the electrode active material can be sufficiently bound to each other at the molecular level and, as a result, the resistive layer at the interface between the electrode active material and the inorganic solid electrolyte is eliminated. For example, there may be mentioned high-frequency welding, thermal welding and ultrasonic welding.

Especially in the case of employing a thermal welding (softening and welding) method, it is preferably performed at the temperature condition which is the thermal decomposition temperature of the polymer compound material or less and for 0.01 to 1 hour. A concrete example of thermal welding is hot pressing.

The electrode for batteries of the present invention is obtained by the electrode production method of such a structure. In the electrode production method of such a structure, the polymer compound material is uniformly dispersed in the inorganic solid electrolyte material in the pulverizing and mixing step; therefore, the resistive layer at the interface between the electrode active material and the inorganic solid electrolyte is eliminated, thereby obtaining an electrode with high ion conductivity.

### EXAMPLES

Hereinafter, the present invention will be explained in more detail by way of examples. However, the present invention is not limited to the examples without departing from the scope of the invention.

### 1. Production of all-Solid-State Secondary Battery

### Example 1

A styrene-butadiene rubber (hereinafter referred to as SBR), which is a kind of polymer compound material, was dissolved in heptane and then mixed with Li₃PS₄, which is a kind of inorganic solid electrolyte, by stirring. The mixed solution was dried in the temperature condition of 120° C. Then, the resultant was pulverized and mixed for 10 hours with a planetary boll mill (P-7 manufactured by Fritsch Japan Co., Ltd.) in the condition of 350 rpm and room temperature (15 to 25° C.), thereby obtaining a polymer compound-containing inorganic solid electrolyte.

The content ratio between the inorganic solid electrolyte and the polymer compound when the total content of them is 100 vol %, was as follows: inorganic solid electrolyte (Li₃PS₄):polymer compound (SBR)=90 vol %:10 vol %. The heptane content when the total content of the inorganic solid electrolyte and the polymer compound is 100 vol %, was 100 vol %.

The polymer compound-containing inorganic solid electrolyte was mixed with LiCoO₂, which is a kind of positive electrode active material, thereby obtaining a composite for positive electrode. The amount of the positive electrode active material was controlled so that the sum of the volume of the polymer compound and that of the inorganic solid electrolyte:the volume of the positive electrode active material=50:50.

The polymer compound-containing inorganic solid electrolyte was mixed with carbon, which is a kind of negative electrode active material, thereby obtaining a composite for negative electrode. The amount of the negative electrode active material was controlled so that the sum of the volume of the polymer compound and that of the inorganic solid electrolyte:the volume of the negative electrode active material=50:50.

The composite for positive electrode was applied to one surface of a solid electrolyte layer containing Li₃PS₄, which is a kind of inorganic solid electrolyte, while the composite for negative electrode was applied to the other surface of the same. The resultant was heat- and pressure-molded by hot pressing at 200° C., thereby obtaining an all-solid-state secondary battery of Example 1.

### Example 2

A polymer compound-containing solid electrolyte was produced in the same manner as Example 1, except that the content ratio between the inorganic solid electrolyte and the polymer compound when the total content of them is 100 vol %, was as follows: inorganic solid electrolyte (Li₃PS₄): polymer compound (SBR)=98 vol %:2 vol %.

An all-solid-state secondary battery of Example 2 was produced in the same manner as Example 1, using the thus-produced polymer compound-containing solid electrolyte.

### Example 3

A polymer compound-containing solid electrolyte was produced in the same manner as Example 1, except that the content ratio between the inorganic solid electrolyte and the polymer compound when the total content of them is 100 vol %, was as follows: inorganic solid electrolyte (Li₃PS₄):polymer compound (SBR)=95 vol %:5 vol %.

An all-solid-state secondary battery of Example 3 was produced in the same manner as Example 1, using the thus-produced polymer compound-containing solid electrolyte.

### Example 4

A polymer compound-containing solid electrolyte was produced in the same manner as Example 1, except that the content ratio between the inorganic solid electrolyte and the polymer compound when the total content of them is 100 vol %, was as follows: inorganic solid electrolyte (Li₃PS₄): polymer compound (SBR)=80 vol %:20 vol %.

An all-solid-state secondary battery of Example 4 was produced in the same manner as Example 1, using the thus-produced polymer compound-containing solid electrolyte.

### Comparative Example 1

Li₃PS₄, which is a kind of inorganic solid electrolyte, was mixed with LiCoO₂, which is a kind of positive electrode active material, at a volume ratio of 50:50, thereby obtaining a composite for positive electrode. Also, Li₃PS₄ was mixed with carbon, which is a kind of negative electrode active material, at a volume ratio of 50:50, thereby obtaining a composite for negative electrode.

The composite for positive electrode was applied to one surface of a solid electrolyte layer containing Li₃PS₄, which is a kind of inorganic solid electrolyte, while the composite for negative electrode was applied to the other surface of the same. The resultant was heat- and pressure-molded by hot pressing at 200° C., thereby obtaining an all-solid-state secondary battery of Comparative Example 1.

### Comparative Example 2

SBR, which is a kind of polymer compound material, was dissolved in heptane. The resulting solution was mixed with Li₃PS₄, which is a kind of inorganic solid electrolyte, and LiCoO₂, which is a kind of positive electrode active material, thereby producing a composite for positive electrode.

Similarly, a solution produced by dissolving SBR in heptane was mixed with Li₃PS₄, which is a kind of inorganic solid electrolyte, and carbon, which is a kind of negative electrode active material, thereby producing a composite for negative electrode.

The final content ratio between the inorganic solid electrolyte, the positive electrode active material and the polymer compound in the composite for positive electrode when the total content of them is 100 vol %, was as follows: inorganic solid electrolyte (Li₃PS₄): positive electrode active material (LiCoO₂): polymer compound (SBR)=40 vol %:50 vol %:10 vol %. The heptane content in the composite for positive electrode was 200 vol %.

The final content ratio between the inorganic solid electrolyte, the negative electrode active material and the polymer compound in the composite for negative electrode when the total content of them is 100 vol %, was as follows: inorganic solid electrolyte (Li₃PS₄):negative electrode active material (carbon):polymer compound (SBR)=40 vol %:50 vol %:10 vol %. The heptane content in the composite for negative electrode was 200 vol %.

The composite for positive electrode was applied to one surface of a solid electrolyte layer containing Li₃PS₄, which is a kind of inorganic solid electrolyte, while the composite for negative electrode was applied to the other surface of the same. The resultant was heat- and pressure-molded by hot pressing at 200° C., thereby obtaining an all-solid-state secondary battery of Comparative Example 2.

### Comparative Example 3

A polymer compound-containing solid electrolyte was produced in the same manner as Example 1, except that the content ratio between the inorganic solid electrolyte and the polymer compound when the total content of them is 100 vol %, was as follows: inorganic solid electrolyte (Li₃PS₄): polymer compound (SBR)=60 vol %:40 vol %.

An all-solid-state secondary battery of Comparative Example 3 was produced in the same manner as Example 1, using the thus-produced polymer compound-containing solid electrolyte.

### Comparative Example 4

A polymer compound-containing solid electrolyte was produced in the same manner as Example 1, except that the content ratio between the inorganic solid electrolyte and the polymer compound when the total content of them is 100 vol %, was as follows: inorganic solid electrolyte (Li₃PS₄): polymer compound (SBR)=40 vol %:60 vol %.

An all-solid-state secondary battery of Comparative Example 4 was produced in the same manner as Example 1, using the thus-produced polymer compound-containing solid electrolyte.

### 2. All-Solid-State Secondary Battery Resistance Measurement

The direct current resistance component of the all-solid-state secondary batteries of Examples 1 to 4 and Comparative Examples 1 to 4, were measured by impedance measurement using an electrochemical measurement system (12608W manufactured by Solartron Analytical).

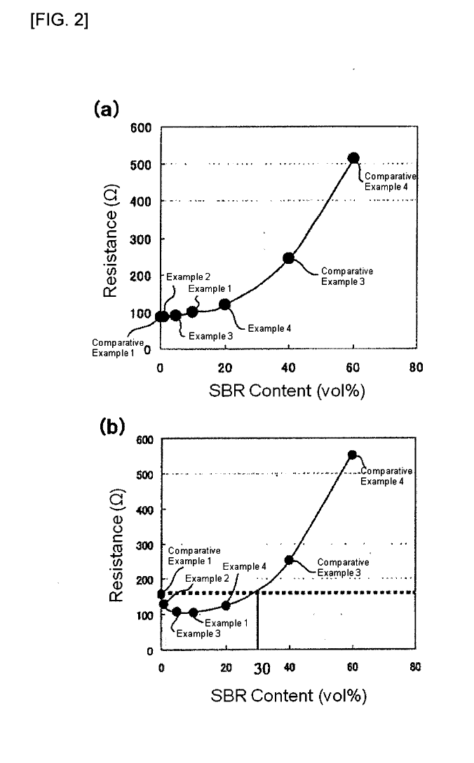

FIG. 2(a) is a graph showing a comparison between the initial resistances of the all-solid-state secondary batteries of Examples 1 to 4 and Comparative Examples 1, 3 and 4. It is a graph with SBR content (vol %) as the horizontal axis and resistance (Ω) as the vertical axis. The SBR content (vol %) shown in the graph means the content of the polymer compound (SBR) when the total content of the inorganic solid electrolyte (Li₃PS₄) and the polymer compound (SBR) is 100 vol %.

As is clear from the graph, the initial resistance increases as the SBR content increases. For example, while the initial resistance of the all-solid-state secondary battery of Comparative Example 1 is 85Ω, which has the positive and negative electrodes each comprising no SBR, the initial resistance of all-solid-state secondary battery of Example 1 is 97Ω, which has the positive and negative electrodes each having a SBR content of 10 vol %.

The initial resistance of the all-solid-state secondary battery of Comparative Example 2 was 957Ω (not plotted in the graph). Among the all-solid-state secondary batteries of Examples 1 to 4 and Comparative Examples 1 to 4, the solid secondary battery of Comparative Example 2 produced not through the pulverizing and mixing step, resulted in the largest initial resistance.

FIG. 2(b) is a graph showing a comparison between the resistances of the all-solid-state secondary batteries of Examples 1 to 4 and Comparative Examples 1, 3 and 4 after 100 cycles of operation. It is a graph with SBR content (vol %) as the horizontal axis and resistance (Ω) as the vertical axis. The SBR content (vol %) shown in the graph means the same thing as in FIG. 2(a).

As is clear from the graph, resistance can be decreased by containing SBR in a certain amount, compared to the all-solid-state battery of Comparative Example 1 which contains no SBR. For example, while the resistance of the all-solid-state secondary battery of Comparative Example 1 is 156Ω after 100 cycles of operation, which has the positive and negative electrodes each comprising no SBR, the resistance of the all-solid-state secondary battery of Example 1 is 104Ω after 100 cycles of operation, which has the positive and negative electrodes each having a SBR content of 10 vol %. As a result of comparing the resistance of Comparative Example 1 in the graph of FIG. 2(b) with that in the graph of FIG. 2(a) and comparing the resistance of Example 1 in the graph of FIG. 2(b) with that in the graph of FIG. 2(a), it is clear that while the resistance of the all-solid-state secondary battery of Comparative Example 1 increased almost two times after 100 cycles of operation, the resistance of the all-solid-state secondary battery of Example 1 showed increased very little even after 100 cycles of operation.

The resistance of the all-solid-state secondary battery of Comparative Example 2 was 1,003Ω after 100 cycles of operation (not plotted in the graph). Among the all-solid-state secondary batteries of Examples 1 to 4 and Comparative Examples 1 to 4, the solid secondary battery of Comparative Example 2 produced not through the pulverizing and mixing step, resulted in the largest resistance after 100 cycles of operation.

It is clear from the graph of FIG. 2(b) that the resistance after 100 cycles of operation of the all-solid-state secondary battery which has the positive and negative electrodes each having a SBR content of 1 to 30 vol %, is lower than the all-solid-state secondary battery of Comparative Example 1 which has the positive and negative electrodes each comprising no SBR.

### REFERENCE SIGNS LIST

1. Electrolyte layer
2. Positive electrode active material layer
3. Negative electrode active material layer
4. Positive electrode current collector
5. Negative electrode current collector
6. Positive electrode
7. Negative electrode
100. All-solid-state lithium battery

1. An electrode for batteries, comprising an inorganic solid electrolyte, an electrode active material and a polymer compound dispersed in the inorganic solid electrolyte,
wherein a content ratio of the polymer compound is 1 to 30 vol % when a total content of the inorganic solid electrolyte and the polymer compound is 100 vol %.

2. The electrode for batteries according to claim 1, wherein the polymer compound is synthetic rubber.

3. The electrode for batteries according to claim 1, wherein the polymer compound is butadiene rubber or styrene-butadiene rubber.

4. The electrode for batteries according to claim 1, wherein the polymer compound is in a powder form.

5. (canceled)

6. A battery comprising at least a positive electrode, a negative electrode and an electrolyte layer present between the positive and negative electrodes,
wherein at least one of the positive and negative electrodes is the electrode for batteries according to claim 1.

7. A method for producing an electrode for batteries, comprising the steps of:
mixing an inorganic solid electrolyte material and a polymer compound material;
pulverizing and mixing the thus-obtained mixture of the inorganic solid electrolyte material and the polymer compound material; and
forming an electrode for batteries by mixing the mixture pulverized and mixed in the pulverizing and mixing step with an electrode active material and then welding them together.
